(19) United States
(12) Patent Application Publication
(10) Pub. No.: US 2016/0171600 A1
(43) Pub. Date: Jun. 16, 2016

(54) Web based method for loan application

(71) Applicant: Blue Global Media, Scottsdale, AZ (US)

(72) Inventors: Christopher Kim Kay, Scottsdale, AZ (US); Zachary Travis Olroyd, Phoenix, AZ (US); Abdu El-Shaarawy, Scottsdale, AZ (US); Erin Elizabeth See, Phoenix, AZ (US); Jessica Lynn Echeverria, Phoenix, AZ (US)

(21) Appl. No.: 14/757,042

(22) Filed: Nov. 12, 2015

Related U.S. Application Data
(60) Provisional application No. 62/123,289, filed on Nov. 13, 2014.

(51) Int. Cl. G06Q 40/02; G06F 17/30; G06F 17/24

(52) U.S. Cl. CPC G06Q 40/025; G06F 17/243; G06F 17/248; G06F 17/30477

(57) ABSTRACT

An SaaS solution for web based loan applications is disclosed that provides for a one-click system for automatically gathering personal data of a loan applicant from internal and external data sources and auto-fills an applicant's personal information into a loan application template. As part of the one click process, the loan application is also processed and the lending decision is sent to the applicant. The one click system enables users to apply for financial services quickly and easily. The system queries internal and external data sources for previous financial service applications and uses the data found to populate a current application, in many cases, eliminating the need for any data input from the user. Through the use of several layers of web, database, and security technologies the system streamlines the application process, reducing the number of steps a user must initiate, to a single click. For situations in which the loan applicant's personal data is not readily available, the one click system may be integrated into legacy platforms to enable data to be added manually.

### CROSS REFERENCE TO RELATED APPLICATIONS

This application claims the benefit and claims priority to U.S. Provisional Patent Application No. 62/123,289, filed on Nov. 13, 2014, hereby incorporated by reference.

### COMPUTER APPENDIX

This application includes a Computer Listing Appendix on compact disc, hereby incorporated by reference.

### BACKGROUND OF THE INVENTION

1. Field of the Invention

The present invention relates to a Software as a Service (SaaS) solution for web based loan applications which simplifies computer processes by adding data awareness and data access to a computer system in order to simplify an on-line loan application process and includes a one-click system for automatically querying various databases in order to locate personal data related to the loan applicant and automatically populate a loan application template with a loan applicant's personal information and automatically processing the loan application and informing the applicant of loan decision.

2. Description of the Prior Art

Various on-line systems are known for applying for a loan. An example of such a system is disclosed in US Patent Application Publication No. US 2012/0303515 A1. In such known systems, the applicants are required to fill out loan application templates with their personal information on each site visit. Whether an applicant has visited web based loan site once or twenty times, the applicant is required to fill in the same personal data and complete all steps for every financial application.

Such prior art on-line loan application systems require manual entry of personal data even if the loan applicant has applied for a loan previously on the same web site. As such, loan applicants must approach each loan application as if it were their first. The reason for this is that known systems have no data awareness capability. These systems are thus unable to access stored personal data and are also lacking the security measures needed to implement such capability. All of these factors result in longer application processes, increased user frustration, and lower loan application conversions.

Thus, there is a need for an on-line loan application system which solves the problems associated with known systems.

### SUMMARY OF THE INVENTION

Briefly, the present invention relates to an improved web based loan application system that is based upon an improved computer process that includes data awareness and automatic data access which solves the problems associated with known systems. The web based loan application system in accordance with the invention provides an easy, fast, and secure way to provide one-click application and processing of a loan application. In addition, the new system may be slotted into existing loan application platforms in a plug-and-play fashion thereby extending the feature sets, usefulness, and lifetime value of legacy web based loan application systems.

### DESCRIPTION OF THE DRAWING

These and other advantages of the present invention will be readily understood with reference to the following specification and attached drawing wherein:

FIG. 1 is a simplified diagram illustrating loan applicant's access to the system in accordance with the present invention.

FIG. 2 is a data flow diagram of the web based loan application system in accordance with the present system.

FIG. 3 is a software logic diagram of the web based loan application system in accordance with the present system.

### DETAILED DESCRIPTION

The present invention relates to a SaaS solution for web based loan applications that provides for a one-click system for automatically querying various databases in order to locate personal data of a loan applicant which auto-fills this information into a loan application template. As part of the process, a completed loan application is automatically processed and the lending decision is sent to the applicant. The solution is based upon an improved computer process that provides data awareness and automatic access to a loan applicant's personal data. The one click system thus enables users to apply for financial services quickly and easily.

The system is configured to automatically query internal and external data sources to locate the locate the loan applicant's personal data, for example, personal data from previous loan applications, and uses that data to automatically populate a current loan application, and, in many cases, eliminating the need for any data input from the user.

Through the use of several layers of web, database, and known security technologies, the system streamlines the application process, thus reducing the number of steps a user must initiate, to a single click. The one click system has the capability to automatically pull data from multiple data sources including independent sources, thus increasing the likelihood that an applicant's data is found. For situations in which the loan applicant's personal data is not readily available, the one click system may be integrated into legacy platforms to enable data to be added manually.

In addition to personal loans, the system is capable of automating business loans, such as vertical loans. A vertical loan is a type of loan for businesses which is based upon multiple tranches of debt in order to obtain a large loan. In particular, the business may offer senior debt, which is secured, and junior or subordinated debt, which is not. A vertical loan allows a business to take on more debt than if it was only offering secured debt, and it lets investors choose whether they want to buy riskier or safer debt. The business uses the services of a bank to structure and issue the loan. The business can offer a variety of tranches; each offering different interest rates and different amounts of collateral.

An important aspect of the invention is that it can automate loan processing even if a loan applicant has never applied for a loan or a business loan. Moreover, the system has the capability to be platform, device, and site independent. In other words, the one click system is capable of streamlining the application process for a loan applicant that has applied in the past from their mobile device on one web site who later applies from their desktop computer through a completely different web site.

Through a robust layer of security and anti-fraud technology, the system detects, recognizes, and populates all required data for the user but prevents unauthorized use and unauthorized data access. Through encryption, secure data transmission, and restricted data access, unauthorized users are unable to access, receive, or manipulate the data sources or data processing.

The system is designed to react dynamically to the user and the data that is available. For example, if twenty data parameters are known about a user but thirty data parameters are needed in order to complete the financial application process, the system dynamically modifies the data input form so that the user is only presented with the form fields that are missing. The already known data is hidden and protected so that unauthorized use and access is prevented.

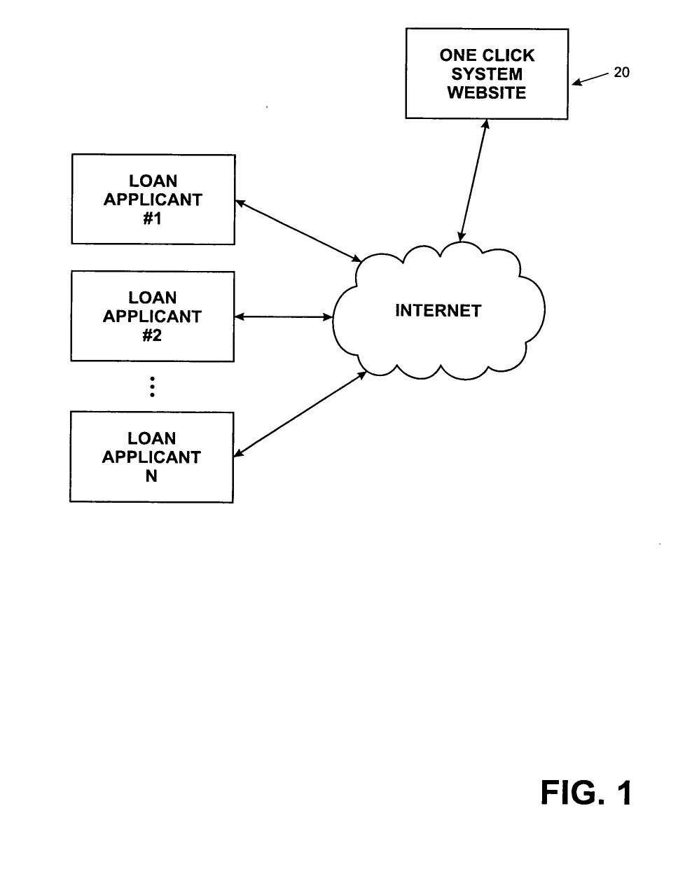

Referring to FIG. 1, the system in accordance with the invention is a web based loan application system. The system enables a loan applicant to apply for a loan on-line by going to a one-click web site, generally identified with the reference numeral 20. The loan applicant can initiate a loan by way of various computer platforms including desktop computers, laptop computers, notebook computers and smart phones.

The system includes a loan application template with various personal data fields. These personal data fields include the applicant's name, address and social security number among other data (hereinafter personal data). All of the personal data fields need to be filled in order to complete the loan application. In known systems, each item of such personal data must be manually completed by the applicant each time the applicant applies for a loan. As will be discussed in more detail below, the system in accordance with the invention searches various internal and external data sources and extracts personal data and auto-populates the personal data fields of the loan application. Auto-population of data fields in an electronic document is known in the art. An example of a system that incorporates auto-population of documents is disclosed in US Patent Application Publication No. US 2014/0249991 A1.

Once the data in the loan application template is completed, the one click system in accordance with the invention automatically processed the loan application according to predetermined conventional or non-conventional criteria. The one-click system notifies the loan applicant of the lending decision, i.e. whether the loan is approved. Thus, with one-click a loan applicant can apply for a loan and find out if the loan is approved with a single click of a mouse by simply clicking on an “APPLY” button on the website 20. For smart phone applications, the loan applicant simply selects an APPLY button.

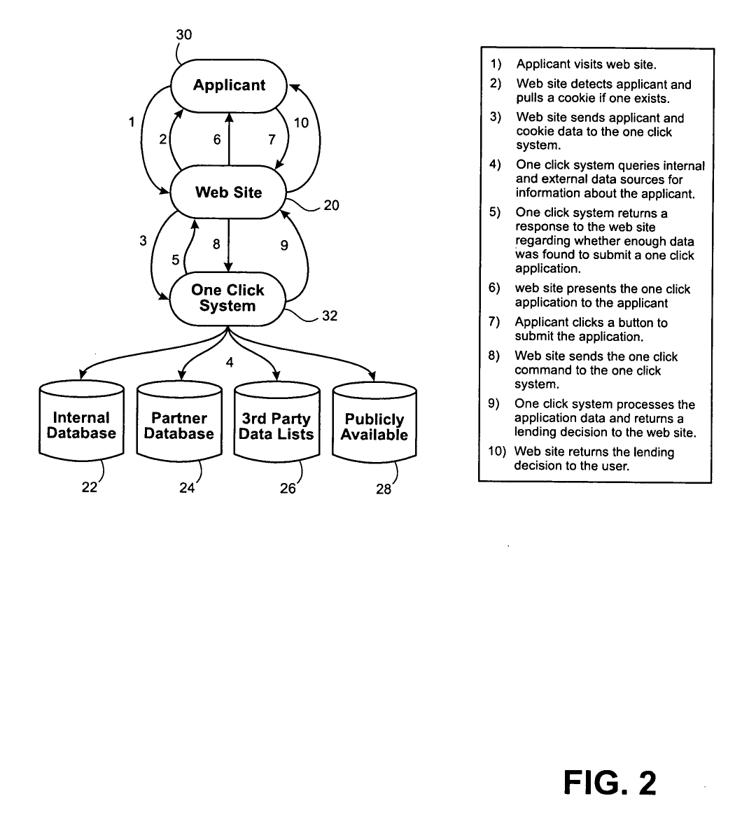

Referring to FIG. 2, a data flow diagram of the web based loan application system in accordance with the present system is illustrated. As shown, the one-click system in accordance with the present invention accesses both internal and external data sources. The internal data source may be an internal database 22, stored in an electronic vault in which the data is encrypted to secure applicant's personal data. Such electronic vaults are known in the art. An example of a system incorporating an electronic vault is disclosed in US Patent Application Publication No, 2011/0270763 A1. The internal database 22 may be additionally or alternatively protected by a firewall.

The internal database 22 is used as a data store for storing personal data of loan applicants. This personal data may be obtained from various sources. One source of personal data may be previous personal loan applications. Such personal data of previous applicants for a loan using the web site 20 (FIG. 1) may be stored in the protected internal database 22, discussed above. Also, data that is collected from external sources may be stored in the protected internal database 22. As will be discussed in more detail below, such personal data is used by the one-click system to auto-populate the loan template mentioned above.

If all necessary data for a loan applicant is not available in the protected internal database 22, the one click system may be configured to automatically search various external databases. These databases may include a partner database 24, a database 26 of 3^{rd} party data lists and publicly available databases, generally identified with the reference numeral 28. Personal information for loan applications gathered by the one click system from the external databases 24, 26 and 28 may be stored in the internal database 24. The system may also check such external databases to determine if the available personal information is still accurate.

The one click system 32 may be implemented as a server and configured as a search engine. For returning customers, the search engine may first check the internal database 22 based upon cookie data received from the web site 20. If all of the information is not available in the internal database 22, the search engine searches the external databases 24, 26 and 28. After the search engine has completed its search, it reports back to the web site 20 whether enough data was located to complete the loan application. If so, the personal data located by the one-click server auto-populates the loan application and a completed loan application is presented to the applicant by the web site. If the information that has been auto-populated in the loan application template is correct in the mind of the applicant, the web site presents the applicant with a button , for example, an APPLY button, that can be clicked or selected in order to apply for a loan. Once the applicant clicks or selects the APPLY button, the command is routed to the one click server 32. The one click server 32 processes the application data and returns a lending decision to the web site 20, which notifies the applicant of the decision.

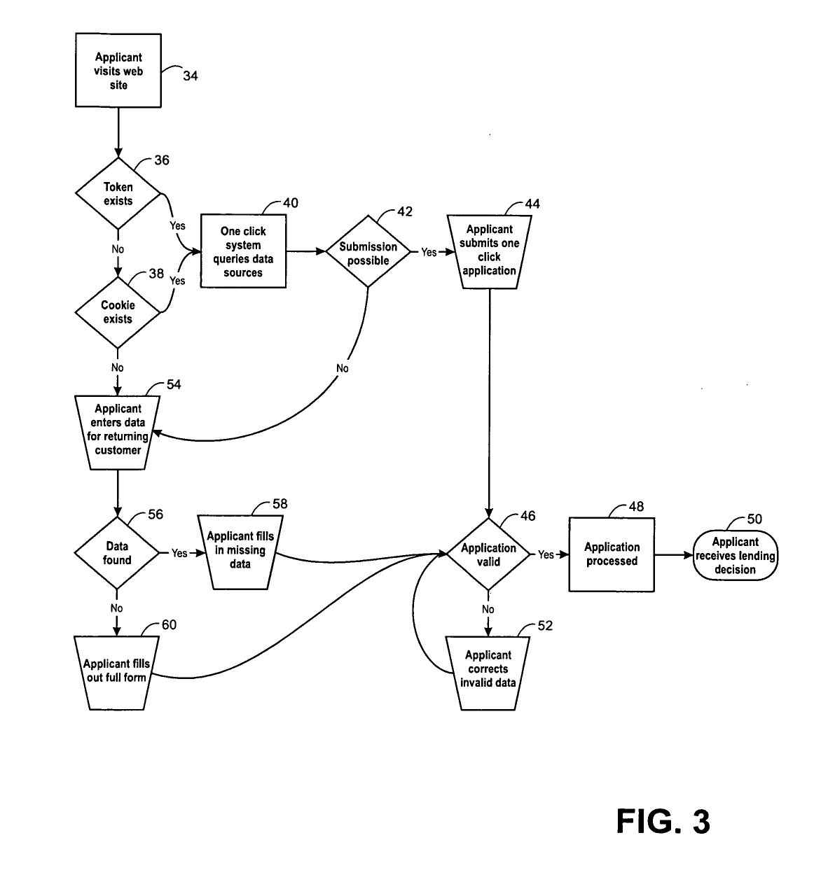

FIG. 3 is a software logic diagram of the web based loan application system in accordance with the present system. In order to apply for a one click on-line loan, the applicant visits the designated website in step 34. Access to the one click system is stream-lined for returning customers. Returning customers can take advantage of the one-click system by way of either software tokens or cookies or both.

Software tokens relate to a two-step security measure which requires a token in the applicant's computing device to match with what is on file at the one step system. In some embodiments, Applicants may be provided with a token after a first transaction or after each transaction.

When an applicant accesses the web the web site 20, the one click server 32 may first check for software tokens in step 36 identifying the Applicant's right to access the system. If the software token matches the system token, access is provided.

Alternatively, if no tokens are provided or in a cookie based system, the system may check for cookies in step 38. When the applicant accesses the website 20, for the first time, a cookie is sent from the web site 20 to the Applicant's web browser and stored with the browser in the Applicant's computer. Later when that applicant goes back to the same website, the web site 20 will recognize the user because of the stored cookie in the Applicant's browser.

As mentioned above, access is stream-lined for return customers. As such, if either a token exists or a cookie exists, the system checks in steps 40 and 42 the internal database 22 as well as external databases 24, 26 and 28 in step 40 to determine if sufficient data is available to complete the personal information on the loan application template. If so, a complete copy of the loan application with an APPLY button is presented to the applicant in step 44. In step 46, the applicant then checks over the accuracy of the personal data on the completed application form to determine if the personal information is correct. If so, the Applicant clicks on the APPLY button in step 48. The completed loan application is sent to the one-click server 32 for processing of the loan application in step 48. In step 50, the lending decision is sent to the web site 20 for information to the applicant.

In step 46, if the Applicant notes errors in the loan application, the Applicant can correct the data in the application in step 52 before clicking on the APPLY button in step 46. The application is processed in step 48 and the lending decision is returned to the web site 20, as above.

If the system finds in steps 36 and 38 that no cookies or tokens exist, for example, or the applicant is using a different computer to apply for the loan, or if sufficient personal data does not exist making a submission not possible, as determined in step 42, the Applicant can enter data regarding previous loan transactions in step 54. If only a portion of the required data is located in the internal database 22 or the external databases 24, 26 and 28, the system may prompt the Applicant to fill in missing data in step 58. The system then proceeds to steps 46-52, as discussed above.

In situations for first time users and situations where no data is found in step 56, the applicant is prompted on the web site 20 to fill out all of the data on the loan application form. The system is then directed to steps 46-52, as discussed above. Steps 60 and 46-52 can be handled by legacy software, which is integrated with the one-click software, discussed above.

Obviously, many modifications and variations of the present invention are possible in light of the above teachings. For example, the system disclosed above can be used for other financial documents, other than loan applications. Thus, it is to be understood that, within the scope of the appended claims, the invention may be practiced otherwise than as specifically described above.

What is claimed and desired to be secured by a Letters Patent of the United States is:

We claim:

1. A method for providing a one-click on-line loan application system, the method comprising the steps;
(a) in response to one click from a prospective loan applicant on a predetermined website, automatically querying one or more databases to determine if information exists in with respect to the prospective loan applicant;
(b) auto-populating a loan application template with any located information;
(c) automatically presenting the loan application template to said prospective loan applicant to check for accuracy or fill in any missing information; and
(d) automatically processing the loan application after it has been completed and verified and returning the loan decision to said loan applicant.

2. The method as recited in claim 1 wherein step (a) includes:
(a) querying an internal database.

3. The method as recited in claim 1 wherein step (a) includes:
(a) querying a partner database.

4. The method as recited in claim 1 wherein step (a) includes:
(a) querying a third party database.

5. The method as recited in claim 1 wherein step (a) includes:
(a) querying a publicly available database.

6. The method as recited in claim 1 wherein step (a) includes:
(a) checking for software tokens.

7. The method as recited in claim 1 wherein step (a) includes:
(a) checking for cookies in the prospective loan applicant's web browser.

8. The method as recited in claim 1 wherein step (a) includes:
(a) checking for tokens and cookies in the prospective loan applicant's web browser.
